(19) United States
(12) Patent Application Publication
(10) Pub. No.: US 2015/0030153 A1
(43) Pub. Date: Jan. 29, 2015

(54) REPEATABLE APPLICATION-SPECIFIC ENCRYPTION KEY DERIVATION USING A HIDDEN ROOT KEY

(71) Applicants: Rajesh P. Banginwar, Bangalore (IN); Taeho Kgil, Foster City, CA (US); Jesse Walker, Hillsboro, OR (US); Gary L. Graunke, Hillsboro, OR (US)

(72) Inventors: Rajesh P. Banginwar, Bangalore (IN); Taeho Kgil, Foster City, CA (US); Jesse Walker, Hillsboro, OR (US); Gary L. Graunke, Hillsboro, OR (US)

(73) Assignee: Intel Corporation, Santa Clara, CA (US)

(21) Appl. No.: 13/995,296

(22) PCT Filed: Feb. 9, 2012
(86) PCT No.: PCT/US12/24527

§ 371 Date: Sep. 4, 2014

(51) Int. Cl. H04L 9/08

(52) U.S. Cl. CPC H04L 9/0861; H04L 2209/24
USPC 380/28

(57) ABSTRACT

Embodiments of an invention for repeatable application-specific encryption key derivation are disclosed. In one embodiment, a processor includes a root key, an encryption engine, and execution hardware. The encryption engine is to perform an encryption operation using the root key, wherein the root key is accessible only to the encryption engine. The execution hardware is to execute instructions to deterministically generate an application-specific encryption key using the encryption algorithm.

### BACKGROUND

1. Field

The present disclosure pertains to the field of information processing, and more particularly, to the, field of encrypting information.

2. Description of Related Art

In an information processing system, secret information may be protected from discovery by encrypting it. Private key encryption algorithms, such as the advanced encryption standard (“AES”) defined in Federal Information Processing Standard 197 from the National Institute of Standards and Technology, use a private key to transform unencrypted information (“plain-text”) into encrypted information (“cipher-text”) that generally has no meaning unless subsequently decrypted by a reverse transformation using the private key.

### BRIEF DESCRIPTION OF THE FIGURES

The present invention is illustrated by way of example and not limitation in the accompanying figures.

FIG. 1 illustrates a processor that supports repeatable application-specific encryption key derivation according to an embodiment of the present invention.

FIG. 2 illustrates a method for repeatable application-specific encryption key derivation according to an embodiment of the present invention.

### DETAILED DESCRIPTION

Embodiments of an invention for repeatable application-specific encryption key derivation using a hidden root key are described. In this description, numerous specific details, such as component and system configurations, may be set forth in order to provide a more thorough understanding of the present invention. It will be appreciated, however, by one skilled in the art, that the invention may be practiced without such specific details. Additionally, some well-known structures, circuits, and other features have not been shown in detail, to avoid unnecessarily obscuring the present invention.

As described in the background section, encryption may he used to protect, secret information. One type of secret information may be application-specific encryption keys. Embodiments of the present invention provide for the repeatable derivation of application-specific encryption keys using a hidden root key. These embodiments provide for the derivation to be repeatable so that the application-specific encryption key need not be stored with the data that it is used to encrypt. These embodiments also provide for the derivation to be performed without comprising protection of the hidden root key.

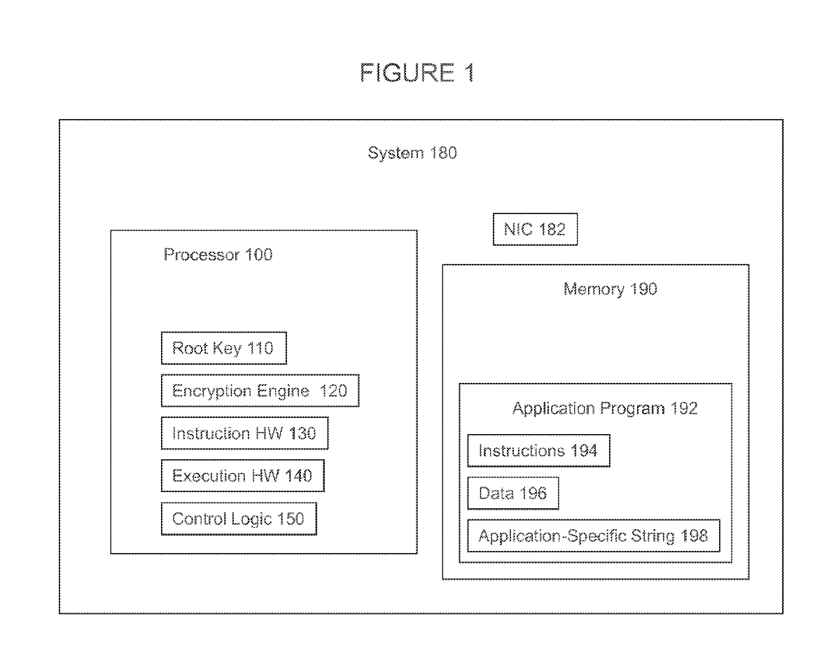

FIG. 1 illustrates processor 100, in system 180; according to an embodiment of the present invention. Processor 100 may be any type of processor, including a general purpose microprocessor, such as a processor in the Intel® Core® Processor Family, Intel® Atom® Processor Family, or other processor family from Intel® Corporation, or another processor from another company, or a special purpose processor or microcontroller. Processor 100 may include multiple threads and multiple execution cores, in any combination. Processor 100 includes root key 110, encryption engine 120, instruction hardware 130, execution hardware 140, and control logic 150. Processor 100 may also include any other circuitry, structures, or logic not shown in FIG. 1.

Root key 110 may be any hardware encryption key. in one embodiment, root key 110 is a 256 bit key stored in a read-only memory implemented in fuses. The read-only memory is inaccessible to software running on processor 100. Only encryption engine 120 has access to root key 110.

Encryption engine 120 may include any circuitry or other structures to execute one or more encryption algorithms in one embodiment, encryption engine 120 includes circuitry to perform AES encryption, secure hash algorithms (“SHA”), and/or hash-based message authentication code (“HMAC”) generation.

Instruction hardware 130 may represent any circuitry, structure, or other hardware, such as an instruction decoder, for fetching, receiving, decoding, and/or scheduling instructions. Any instruction format may be used within the scope of the present invention; for example, an instruction may include an opcode and one or more operands, where the opcode may be decoded into one or more micro-instructions or micro-operations for execution by execution hardware 140.

In one embodiment, instruction hardware 130 may be designed to receive one or more instructions to support the operation of processor 100 in a secured or isolated execution mode, in which access to particular system resources may be controlled by trusted software such as a measured virtual machine monitor. In this embodiment, access to encryption engine 120 may be limited to software operating within the secured or isolated execution mode. In other embodiments, any other approach to hiding or protecting root key 110 may be used. In one embodiment, root key 110 is accessible only to an AES wrap operation that is performed entirely by encryption engine 120 and is riot observable by any other hardware or software.

Execution hardware 140 may include any circuitry, structure, or other hardware, such as an arithmetic unit, logic unit, floating point unit, shifter, etc for processing data and executing instructions, micro-instructions, and/or micro-operations.

Control logic 150 may include any circuitry, logic, or other structures, including microcode, state machine logic, and programmable logic, to control the operation of the units and other elements of processor 100 and the transfer of data within, into, and out of processor 100. Control logic 150 may cause processor 100 to perform or participate in the performance of method embodiments of the present invention, such as the method embodiments described below, for example, by causing processor 100, using execution hardware 140, encryption engine 120, and/or any other resources, to execute instructions received by instruction hardware 130 and micro-instructions or micro-operations derived from instructions received by instruction hardware 130.

System 180 may also include system memory 190, network interface controller (“NIC”) 182, and any other components any other components or other elements connected, coupled, or otherwise in communication with each other through any number of buses, point-to-point, or other wired or wireless connections. System memory 190 may include dynamic random access memory and/or any other type of medium accessible by processor 100, and may he used to store data and/or instructions used or generated by processor 100 and/or any other components. For example, system memory 190 is shown as storing application program 192, including application instructions 194, application data 196, and application-specific string 198, as described below. NIC 182 may be any type of controller used to enable communication between system 190 and another information processing system.

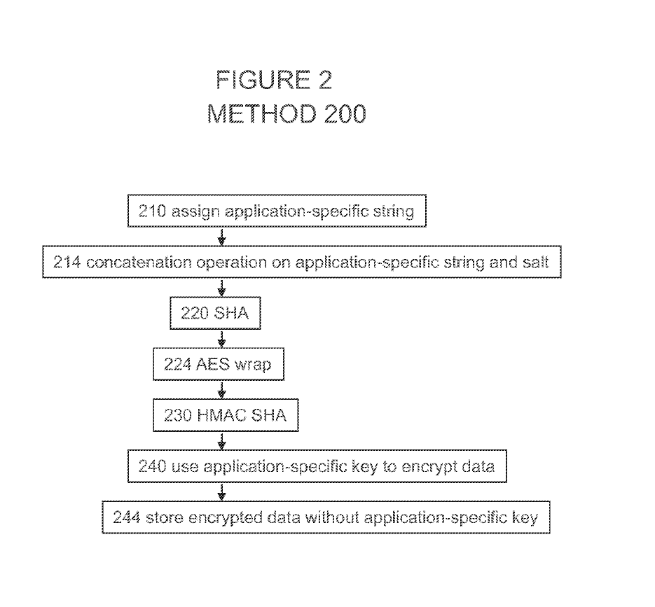

FIG. 2 illustrate method 200 for repeatable application-specific encryption key derivation according to an embodiment of the present invention. Although method embodiments of the invention are not limited in this respect, reference may be made to elements of FIG. 1 to help describe the method embodiment of FIG. 2.

In box 210 of method 200, a unique data string, such as application-specific string 196 is assigned to an application running on processor 100. Each application running on processor 100 for which an application-specific key is needed or desired may be assigned pits own unique data string generated according to any approach. In box 214, a concatenation operation is performed on application-specific string 196 and a salt. In one embodiment, the salt may be a platform-specific string, such as the MAC of NIC 182.

In box 220, art SHA is performed on the result of the concatenation operation from box 214. In one embodiment, an SHA-256 algorithm is used to provide a 256-bit input to box 224. In box 224, an AES wrap is performed on the SHA output from box 220 by encryption engine 130. The AES wrap function performs an AES operation using root key 210.

In box 230, an SHA is performed on the output of the AES wrap from box 224. in one embodiment, an HMAC-SHA-256 algorithm is used to provide a 256-bit application-specific key. Any HMAC key may be used for this operation.

The output of the SHA operation of box 230 is a key that is unique to application 192. Since the operations of boxes 214, 220, 224, arid 230 are deterministic, an application may use method 200 to generate the same application-specific key again and again. Therefore, there is no need to store the application-specific key.

In box 240, the application-specific key may be used to encrypt data. In box 244, the encrypted data may be stored, for example, in application data area 196. Within the scope of the present invention, method 200 may be performed in a different order, with illustrated boxes omitted, with additional boxes added, or with a combination of reordered, omitted, or additional boxes.

Embodiments or portions of embodiments of the present invention, as described above, may be stored in any form of a machine-readable medium. For example, all or part of method 200 may be embodied in software or firmware instructions that are stored on a medium readable by processor 100, which when executed by processor 100, cause processor 100 to execute an embodiment of the present invention.

Thus, embodiments of an invention for repeatable application-specific encryption key derivation have been described. While certain embodiments have been described, and shown in the accompanying drawings, it is to be understood that such embodiments are merely illustrative and not restrictive of the broad invention, and that this invention not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

What is claimed is:

1. A processor comprising;
a root key;
an encryption engine to perform an encryption algorithm using the root key, wherein the root key is accessible only to the encryption engine; and
execution hardware to execute instructions to deterministically generate an application-specific encryption key using the encryption algorithm.

2. The processor of claim 1, wherein the root key is stored in a read-only fuse memory.

3. The processor of claim 1, wherein the encryption algorithm is an advanced encryption standard (AES) algorithm.

4. A method comprising:
deriving a first value from an application-unique string; and
performing, by a hardware encryption engine, an encryption operation using a root key accessible only to the hardware encryption engine to provide a unique key to an application.

5. The method of claim 4, wherein the encryption operation is an advanced encryption standard (AES) operation.

6. The method of claim 4, further comprising assigning the application-unique string to the application prior to deriving the first value.

7. The method of claim 4, wherein deriving the first value includes using a platform-specific string as salt.

8. The method of claim 7 wherein deriving the first value includes a concatenation operation.

9. The method of claim 8, wherein deriving the first value includes a performing a secure hash algorithm on a result of the concatenation operation.

10. The method of claim 4, wherein performing the encryption operation to provide the unique key includes performing a secure hash algorithm on a result of the encryption operation.

11. The method of claim 10, wherein performing the secure hash algorithm on the result of the encryption operation includes using a hash-based message authentication code.

12. The method of claim 4, further comprising using, by the application, the unique key to encrypt data and storing the data without the unique key.

13. A machine-readable medium including instructions that, when executed, cause a processor to:
derive a first value from an application-unique string; and
perform, by a hardware encryption engine in the processor, an encryption operation using a root key accessible only to the hardware encryption engine to provide a unique key to an application running on the processor.

14. The machine-readable medium of claim 13, Wherein the encryption operation is an advanced encryption standard (AES) operation.

15. The machine-readable medium of claim 13, also including instructions that cause the processor to assign the application-unique string to the application prior to deriving the first value.

16. The machine-readable medium of claim 13, wherein deriving the first value includes using a platform-specific string as salt.

17. The machine-readable medium of claim 16, wherein deriving the first value includes a concatenation operation.

18. The machine-readable medium of claim 17, wherein deriving the first value includes a performing a secure hash algorithm on a result of the concatenation operation.

19. The machine-readable medium of claim 13, wherein performing the encryption operation to provide the unique key includes performing a secure hash algorithm on a result of the encryption operation.

20. The machine-readable medium of claim 19, wherein performing the secure hash algorithm on the result of the encryption operation includes using a hash-based message authentication code.
